(19) United States
(12) Patent Application Publication
(10) Pub. No.: US 2022/0306542 A1
(43) Pub. Date: Sep. 29, 2022

(54) YTTRIUM OXIDE-BASED SINTERED BODY, PRODUCTION METHOD THEREFOR, AND MEMBER FOR SEMICONDUCTOR PRODUCTION APPARATUS

(71) Applicant: NGK SPARK PLUG CO., LTD., Nagoya-shi (JP)

(72) Inventors: Yuki TAKAHASHI, Nagoya-shi (JP); Yoshifumi TSUTAI, Nagoya-shi (JP)

(21) Appl. No.: 17/703,261

(22) Filed: Mar. 24, 2022

(30) Foreign Application Priority Data
Mar. 26, 2021 (JP) 2021-053353

(51) Int. Cl. C04B 35/505; C04B 35/626; C04B 35/64

(52) U.S. Cl. CPC C04B 35/505; C04B 35/62695; C04B 35/64; C04B 2235/3225; C04B 2235/3217; C04B 2235/786; C04B 2235/77; C04B 2235/728; C04B 2235/725; C04B 2235/656

(57) ABSTRACT

An yttrium oxide-based sintered body includes yttrium oxide as a predominant component. The sintered body includes aluminum in an amount of 0.1 mass % to 0.5 mass % inclusive as reduced to aluminum oxide, has a metal content of 1,000 ppm or less, the metal excluding yttrium and aluminum, and has a relative density of 98% or higher. By virtue of the yttrium oxide-based sintered body, a plasma resistance comparable to that of a high-purity (99.9%) yttrium oxide sintered body can be achieved. Also, since the relative density is sufficiently high, plasma resistance can be enhanced. As a result, the yttrium oxide-based sintered body can be suitably used as a large-scale member by virtue of excellent mechanical strength.

### BACKGROUND OF THE INVENTION

### (1) Field of the Invention

The present invention relates to an yttrium oxide-based sintered body, to a method for producing the yttrium oxide-based sintered body (hereinafter may be referred to as a “yttrium oxide-based sintered body production method”), and to a member for use in a semiconductor production apparatus (hereinafter may be referred to as a “semiconductor production apparatus member”).

### (2) Background Art

Hitherto, members or parts of a semiconductor production apparatus, in particular those employed under plasma conditions, are formed of sintered yttrium oxide (Y₂O₃), which has high resistance to plasma. Such a semiconductor production apparatus member must cause no contamination of a workpiece (i.e., a subject to be processed) with impurities (particles and the like). Thus, such a member is formed of a high-purity yttrium oxide sintered body.

Generally, in a yttria ceramic containing a trace amount of a metallic component, the component tends to be segregated at the grain boundary of yttria crystal grains. When such a yttria ceramic member containing a trace metallic component is placed in a plasma atmosphere, corrosion is triggered at the grain boundary, since the metallic component is more susceptible to corrosion than yttria crystals in a plasma atmosphere. Once the grain boundaries of yttria crystals near the surface of the yttria ceramic are corroded, some yttria crystal grains are eliminated from the yttria ceramic, and the eliminated grains are deposited on a silicon wafer (i.e., a workpiece) as dust. In order to solve this problem, Patent Document 1 discloses a yttria ceramic part which has a purity of 99.9 wt % or higher and a trace metal content (by mass) of 100 ppm (Si) and 20 ppm (Ca).

Also, Patent Document 2 discloses an anti-corrosive ceramic member containing yttrium oxide as a major component, and at least one element of Zr, Si, Ce, and Al as a sintering aid each in an amount of 3 ppm (by mass) to 2,000 ppm (by mass) inclusive.
Patent Document 1: Japanese Patent No. 4798693
Patent Document 2: Japanese Patent No. 4548887

### SUMMARY OF THE INVENTION

Yttrium oxide is a material which is not easily sintered. Thus, high-temperature firing is required for converting high-purity yttrium oxide to a dense sintered body thereof.

According to Patent Document 1, a calcined ceramic body of yttria is fired under hydrogen at a high temperature (1,700° C. to 1,850° C. inclusive). However, high-temperature firing promotes growth of crystal grains, and the resultant member is formed of large crystal grains. In this case, release of grains readily occurs, and corrosion proceeds from the sites where grains have been eliminated. As a result, plasma resistance is impaired.

According to Patent Document 2, the anti-corrosive ceramic member is formed by use of a sintering aid containing at least one element of Zr, Si, Ce, and Al. When the yttrium oxide sintered body contains a sintering aid containing a plurality of metals, a sintering aid component is segregated, whereby a portion exhibiting poor plasma resistance may be possibly provided. In addition, although the sintering aid can lower the firing temperature, firing at about 1,700° C. is required for producing an yttrium oxide sintered body having high purity and density.

The present invention has been conceived in view of the foregoing. Thus, an object of the present invention is to provide an yttrium oxide-based sintered body which can be produced by firing at lower temperature and which has high plasma resistance. Another object is to provide a method for producing such an yttrium oxide-based sintered body. Still another object is to provide a member for use in a semiconductor production apparatus.

In accordance with one aspect of the invention, an yttrium oxide-based sintered body includes (i.e. is formed of) yttrium oxide as a predominant component. The sintered body includes (i.e., contains) aluminum in an amount of 0.1 mass % to 0.5 mass % inclusive as reduced to aluminum oxide, has a metal content of 1,000 ppm or less, the metal content excluding yttrium and aluminum, and has a relative density of 98% or higher.

By virtue of the above-described yttrium oxide-based sintered body which is based on yttrium oxide and which contains a small amount of aluminum oxide and a possibly limited amount of metal other than yttrium and aluminum, a plasma resistance comparable to that of a high-purity (99.9%) yttrium oxide sintered body can be achieved. Also, since the relative density is sufficiently high, plasma resistance can be enhanced. As a result, the yttrium oxide-based sintered body can be suitably used as a large-scale member by virtue of excellent mechanical strength.

The yttrium oxide-based sintered body may have a mean grain size of 1 μm to 10 μm inclusive.

Through reduction of the mean grain size of crystal grains forming the yttrium oxide-based sintered body, possible release of crystal grains from the yttrium oxide-based sintered body can be prevented, whereby a drop in plasma resistance can be suppressed.

The yttrium oxide-based sintered body may contain a complex oxide of yttrium and aluminum, and the complex oxide is present at an area ratio of 0.5% to 5% inclusive, the area ratio being determined in a Scanning Electron Microscope (SEM) image of a cross section of the sintered body.

Through adjusting the area ratio of the complex oxide, as determined in the SEM image, to fall within a specific range, the crystallinity of the yttrium oxide-based sintered body can be enhanced, whereby the plasma resistance can be further enhanced.

The yttrium oxide-based sintered body may have an Si content, a Ca content, and an Na content of 150 ppm or less, respectively.

Through reducing the amounts of Si, Ca, and Na to a minimum level, the plasma resistance of the yttrium oxide-based sintered body can be further enhanced. This effect is advantageous, since Si, Ca, and Na considerably affect the plasma resistance.

In accordance with another aspect of the invention, a semiconductor production apparatus member includes (i.e. is formed of) the yttrium oxide-based sintered body as described above.

According to this technical feature, a semiconductor production apparatus member can be fabricated from an yttrium oxide-based sintered body having a plasma resistance comparable to that of a high-purity yttrium oxide sintered body and a high mechanical strength, whereby cost for semiconductor production apparatus can be reduced.

In accordance with yet another aspect of the invention, a method for producing an yttrium oxide-based sintered body includes: weighing yttrium oxide and aluminum oxide so that the sintered body contains, after sintering, yttrium oxide in an amount of 99.4 mass % or more and aluminum in an amount of 0.1 mass % to 0.5 mass % inclusive, as reduced to aluminum oxide; adding a binder to the weighed material and mixing; granulating the mixed material to form a granulated powder; forming the granulated powder into a compact; and firing the compact at 1,500° C. to 1,700° C. inclusive.

As described above, since a small amount of aluminum oxide is added as a sole sintering promoter to yttrium oxide, the formed complex oxide also serves as a material having excellent plasma resistance, and the aluminum content is sufficiently reduced. Therefore, the plasma resistance of the thus-formed yttrium oxide-based sintered body can be enhanced to a level comparable to that of a high-purity (99.9%) yttrium oxide sintered body. Since aluminum oxide contained in yttrium oxide forms a complex oxide that can promote sintering, firing can be performed at lower temperature (1,700° C. or lower), whereby growth of crystal grains forming the yttrium oxide-based sintered body can be suppressed. As a result, release of crystal grains from the yttrium oxide-based sintered body can be minimized, whereby a drop in plasma resistance can be suppressed. In addition, the relative density can be enhanced through firing at 1,500° C. or higher. As a result, plasma resistance can be also enhanced. The thus-formed sintered body can be suitably used as a large-scale member by virtue of excellent mechanical strength.

In one embodiment, the aluminum oxide is added as alumina sol.

According to this technical feature, dispersibility of aluminum oxide is enhanced, and growth of crystal grains forming the sintered body can be further suppressed. As a result, a drop in plasma resistance, which would otherwise be caused by release of crystal grains, can be further suppressed.

According to the present invention, plasma resistance of the yttrium oxide-based sintered body can be enhanced to a sufficient level. The production method of the present invention allows firing at lower temperature and enables production of an yttrium oxide-based sintered body having satisfactorily high plasma resistance. The semiconductor production apparatus member of the present invention has high plasma resistance and can be suitably used as a large-scale member by virtue of excellent mechanical strength of the source sintered body.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1 is a schematic cross-section of a semiconductor production apparatus according to an embodiment of the present invention, showing a mode of use of members of the apparatus;

FIG. 2 is a flowchart showing an example of steps of producing an yttrium oxide-based sintered body according to the embodiment of the present invention;

FIG. 3 is a table showing data relating to sintered bodies of Examples, Comparative Examples, and Referential Examples (proportions of raw materials, firing temperature for sintering, and evaluation results);

FIG. 4 is an SEM image of an yttrium oxide-based sintered body of Example 1;

FIG. 5 is an SEM image of an yttrium oxide-based sintered body of Example 6;

FIG. 6 is an SEM image of an yttrium oxide-based sintered body of Example 7; and

FIG. 7 is an SEM image of a sintered body of Comparative Example 1.

### DETAILED DESCRIPTION OF PREFERRED EMBODIMENTS

With reference to the drawings, an embodiment of the present invention will be described. For the purpose of easy understanding of the description, the same constitutional elements in the drawings are denoted by the same reference numeral, and repeated description is omitted. In the configuration diagram, the dimensions of each constitutional element are conceptually given and do not represent the actual scale.

(1) Material Features of Yttrium Oxide-Based Sintered Body

The yttrium oxide-based sintered body of the present invention is formed of yttrium oxide (Y₂O₃) as a predominant component, wherein the sintered body contains aluminum in an amount of 0.1 mass % to 0.5 mass % inclusive as reduced to aluminum oxide (Al₂O₃), has a metal content of 1,000 ppm or less, the metal excluding yttrium and aluminum. The expression “yttrium oxide as a predominant component” refers to the yttrium oxide content being 99.4 mass % or more and less than 99.9 mass %.

Thus, the yttrium oxide-based sintered body is based on yttrium oxide and contains a small amount of aluminum oxide and a possibly limited amount of metal other than yttrium and aluminum. As a result, a plasma resistance of the sintered body comparable to that of a high-purity (99.9%) yttrium oxide sintered body can be achieved.

When the aluminum oxide content is less than 0.1 mass %, the effect of promoting sintering is poor, and difficulty is encountered in densification through firing at lower temperature (1,700° C.). However, since growth of crystal grains forming the sintered body is suppressed through firing at lower temperature, there can be suppressed a drop in plasma resistance which would otherwise be caused by release of crystal grains from the yttrium oxide-based sintered body. In addition, lowering the firing temperature leads to protection of a firing furnace and reduction of production cost. When the aluminum oxide content is in excess of 0.5 mass %, segregation of aluminum oxide may occur. In the case of occurrence of segregation of aluminum oxide, plasma resistance is impaired. For the above reasons, the aluminum oxide content is tuned to fall within the aforementioned range. Thus, the aluminum oxide content is preferably 0.2 mass % or more, and 0.4 mass % or less, more preferably 0.3 mass % or less.

Also, when the amount of metal other than yttrium and aluminum is adjusted to 1,000 ppm (0.1 mass %) or less, satisfactory plasma resistance can be secured. Such trace metals tend to be concentrated mainly at the grain boundary phase of the yttrium oxide sintered body, and corrosion of the trace metals under plasma conditions more easily proceeds, as compared with yttrium oxide and aluminum oxide. Once corrosion of the trace metal component proceeds first, release of crystal grains occurs due to corrosion at the grain boundary, to thereby impair plasma resistance. For this reason, the amount of metal other than yttrium and aluminum is preferably as small as possible. Thus, the amount of metal other than yttrium and aluminum is preferably 500 ppm or less, more preferably 300 ppm or less. The lower limit of the amount of metal other than yttrium and aluminum is preferably as small as possible. However, since there is present an impurity unavoidably incorporated into the yttrium oxide sintered body from raw materials or in the production step, the lower limit may be adjusted to 1 ppm or more.

As described above, by use of a sintering aid solely containing aluminum oxide, a drop in local plasma resistance attributed to a compositional feature causing poor plasma resistance is suppressed, to thereby achieve uniform distribution in plasma resistance of a semiconductor production apparatus member. Notably, in order to adjust the trace metal content to fall within the aforementioned range, rigorous control is required to intrusion of impurities from raw material powder and in production steps.

From another aspect, the yttrium oxide-based sintered body of the present invention has a relative density of 98% or higher. By virtue of sufficiently high relative density, plasma resistance can be enhanced, and the yttrium oxide-based sintered body can be suitably used as a large-scale member by virtue of excellent mechanical strength.

The relative density of the yttrium oxide-based sintered body is represented by “[(density of sintered body)/(theoretical density)]×100 (%).” The theoretical density is defined as a density of yttrium oxide (5.01 g/cm³), and the density of sintered body is a density of the yttrium oxide-based sintered body measured through Archimedes' principle.

Preferably, the yttrium oxide-based sintered body has a mean grain size of 1 μm to 10 μm inclusive. By reducing the mean grain size of crystal grains forming the yttrium oxide-based sintered body, possible release of grains from the yttrium oxide-based sintered body can be prevented, whereby a drop in plasma resistance can be suppressed.

The mean grain size of the yttrium oxide-based sintered body refers to a mean grain size of the crystal grains forming the yttrium oxide-based sintered body. The mean grain size may be obtained through the following procedure. Specifically, an yttrium oxide-based sintered body sample is cut, and a cut surface of the body is polished. The polished surface is subjected to thermal etching. Then, an SEM (scanning electron microscopic) image is taken, and the thus-obtained photographic image is processed by image analysis by software (WinROOF, product of Mitani Corporation), to thereby calculate a circle equivalent diameter. Through this procedure, the mean grain size of the vision field can be determined. This measurement is performed in 3 to 5 vision fields, and the averaged value is employed as the mean grain size.

Alternatively, the yttrium oxide-based sintered body of the present invention preferably contains a complex oxide of yttrium and aluminum, and the complex oxide is present at an area ratio of 0.5% to 5% inclusive, the area ratio being determined in an SEM image of a cross section of the sintered body. Thus, through adjusting the area ratio of the complex oxide, as determined by an SEM image, to fall within a specific range, the crystallinity of the yttrium oxide-based sintered body can be enhanced, to thereby further enhance plasma resistance. Also, reaction of forming a complex oxide of yttrium and aluminum in the sintered body can promote sintering, whereby a lower firing temperature can be employed. Notably, the concept “complex oxide of yttrium and aluminum” refers to YAG(Y₃Al₅O₁₂), YAP(YAlO₃), YAM(Y₄Al₂O₉), and the like.

The area ratio of the complex oxide may be calculated by observing a cross section of a target sintered body under a scanning electron microscope (SEM, ×1,000) and processing the obtained photographic image by image analysis software (WinROOF, product of Mitani Corporation). In a specific procedure, a vision field (100 μm×100 μm) of the thus-obtained image data is binarized. The observation is performed in 3 to 5 vision fields selected at random.

Meanwhile, formation of a complex oxide of yttrium and aluminum can be confirmed by subjecting a cross section of the yttrium oxide-based sintered body to high-power XRD analysis. Through high-power XRD analysis, the compositional information of grains having different contrast in the SEM image is confirmed. Subsequently, the grains which have been confirmed as a complex oxide are employed as target grains. The grains are subjected to the aforementioned image analysis, to thereby determine the area ratio of the complex oxide. Notably, the area of pores, which are observed as black spots in the SEM image of the cross section, are removed from the total area in calculation.

Also preferably, the yttrium oxide-based sintered body has an Si content, a Ca content, and an Na content of 150 ppm or less, respectively. Through reducing the amounts of Si, Ca, and Na to a minimum level, the plasma resistance of the yttrium oxide-based sintered body can be further enhanced. This effect is advantageous, since Si, Ca, and Na considerably affect the plasma resistance. Thus, each of the Si content, the Ca content, and the Na content is more preferably 100 ppm or less, still more preferably 50 ppm or less. The metal content of the yttrium oxide-based sintered body may be determined through glow discharge mass spectrometry (GDMS).

(2) Structure of Semiconductor Production Apparatus Member

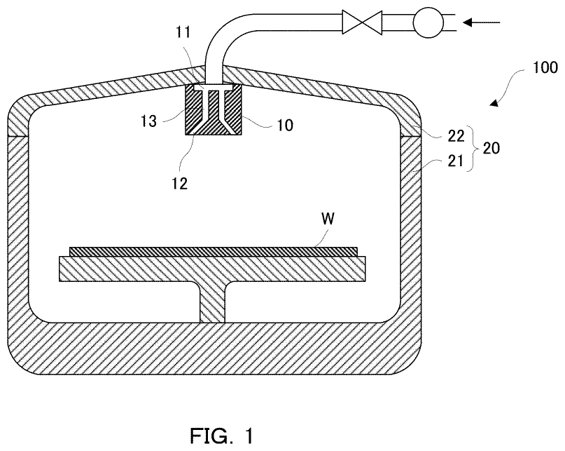

Next, the semiconductor production apparatus member of the present invention will be described. FIG. 1 is a schematic cross-section of a semiconductor production apparatus according to the embodiment of the present invention, showing a mode of use of members of the apparatus. The semiconductor production apparatus member of the present invention is employed as, for example, a gas nozzle 10 used in a plasma apparatus 100 working in a semiconductor production step or a liquid crystal production step. The apparatus is, for example, a film forming apparatus for forming thin film on a substrate W (e.g., a semiconductor wafer or a glass substrate), or an etching apparatus for micro-processing a substrate W.

In one mode of operation of the film forming apparatus, a raw material gas containing a corrosive gas is fed through the gas nozzle 10 into a reaction chamber 20. Through plasma chemical vapor deposition (CVD), the raw material gas is converted into gas plasma, whereby a thin film is formed on the substrate W. In another mode of operation of the etching apparatus, a halogen-containing corrosive gas serving as a raw material gas is fed through the gas nozzle 10 into a reaction chamber 20. The corrosive gas is converted into gas plasma, which can serve as an etching gas, and the substrate W is subjected to a micro-processing with the etching gas.

The gas nozzle 10 is provided with a gas feed inlet 11 through which a gas (e.g., a corrosive gas) is supplied from a gas supplying section (not illustrated), a gas discharge outlet 12 through which the gas is discharged to the reaction chamber 20, and nozzle holes 13 which communicate through the gas feed inlet 11 and the gas discharge outlet 12.

The semiconductor production apparatus member according to the embodiment of the present invention is a member having a part which is to be exposed to corrosive gas. Examples of the part of the gas nozzle 10, which part is exposed to corrosive gas, include a member forming at least a part including nozzle holes 13 and a part exposing to the reaction chamber 20. Alternatively, the semiconductor production apparatus member may form the entirety of the gas nozzle 10. Also, the anti-corrosive member may be, for example, the entirety or a part of a chamber body 21 or a lid 22 of the reaction chamber 20.

(3) Yttrium Oxide-Based Sintered Body Production Method

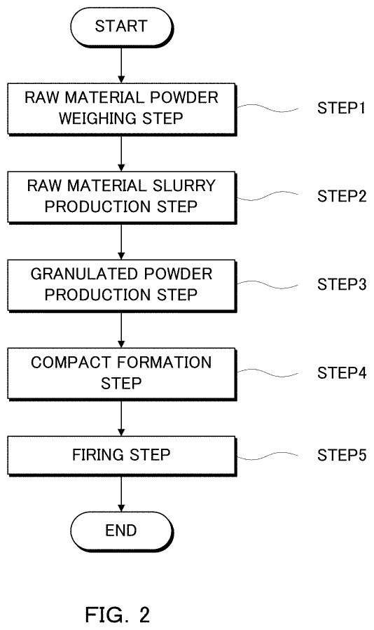

Next will be described a method for producing the yttrium oxide-based sintered body of the present invention. FIG. 2 is a flowchart showing an example of steps of producing an yttrium oxide-based sintered body according to the embodiment of the present invention.

Firstly, there are provided an yttrium oxide powder and an aluminum oxide powder serving as raw materials of an yttrium oxide-based sintered body. Each raw material powder preferably has a purity of 99.9% or higher, more preferably 99.99% or higher. Also, each powder preferably has a mean particle size of 0.1 μm to 2.0 μm inclusive. Then, each powder is weighed so that the yttrium oxide-based sintered body contains, after sintering, aluminum in an amount of 0.1 mass % to 0.5 mass % inclusive, as reduced to aluminum oxide (STEP 1).

Next, the raw material powders are mixed together. The powders are fed to a pot with, for example, a binder (e.g., PVA), and the mixture is pulverized by means of a ball mill under wet conditions, to thereby prepare a raw material slurry (STEP 2). In the preparation of the raw material slurry, deionized water or a dispersant may also be used. The ball mill employed here may be, for example, an aluminum ball mill. The mixing time may be adjusted to, for example, 20 hours.

Next, the slurry obtained in the mixing step is dried and granulated (STEP 3). In one procedure of yielding a granulated powder from the slurry, a slurry is heated in hot water for removing the solvent, to thereby yield a powder product, and the thus-obtained powder is sieved. Alternatively, spray drying may be employed.

Next, the granulated powder produced in the granulation step is molded to form a compact (STEP 4). In one mode of molding, the obtained granulated powder is put into a mold and subjected to press molding. Press molding may be performed through a known method such as uniaxial press molding, cold isostatic pressing (CIP), or hot pressing. In the case of press molding, the pressure for pressing may be adjusted to, for example, 98 MPa.

Next, the compact is fired (STEP 5). Firing the compact in an oxidizing atmosphere or in vacuum at 1,500° C. to 1,700° C. inclusive can produce an yttrium oxide-based sintered body. The firing time is preferably 1 hour to 20 hours inclusive. Notably, if required, a debindering step may be added prior to the firing step. Also, there may be performed a densification step in which the yttrium oxide-based sintered body is pressed through HIP.

Preferably, the aluminum oxide raw material is provided as alumina sol, and the alumina sol is added. By use of alumina sol, dispersion of aluminum oxide is maximized, to thereby further suppress growth of crystal grains forming the sintered body. As a result, a drop in plasma resistance which would otherwise be caused by release of grains can be further suppressed.

Through the steps described above, there can be produced an yttrium oxide-based sintered body having a plasma resistance comparable to that of a high-purity yttrium oxide sintered body.

### EXAMPLES

### Example 1

An yttrium oxide raw material powder (purity: 99.9%, mean grain size 1 μm) and an aluminum oxide raw material powder (purity 99.99%, mean grain size 0.2 μm) were weighed so that the aluminum oxide of the yttrium oxide-based sintered body was adjusted to 0.1 mass %. Subsequently, the thus-prepared raw material powder was added to a pot with a PVA binder (additionally 2.0 mass %), an aqueous acrylic dispersant (additionally 0.3 mass %), and deionized water (appropriate amount), and the mixture was sufficiently agitated under wet conditions by means of a ball mill, to thereby form a raw material slurry. The thus-obtained raw material slurry was dried and granulated by means of a spray-dryer. The thus-granulated powder was fed into a mold and pressed through cold isostatic pressing (CIP), to thereby prepare a compact. The thus-obtained compact was fired at 1,600° C. in air for 10 hours, to thereby yield an yttrium oxide-based sintered body of Example 1.

### Example 2

The procedure of the Example 1 was repeated, except that weighing was performed so as to adjust the aluminum oxide of the sintered body to 0.2 mass %, to thereby produce an yttrium oxide-based sintered body of Example 2.

### Example 3

The procedure of the Example 1 was repeated, except that weighing was performed so as to adjust the aluminum oxide of the sintered body to 0.3 mass %, to thereby produce an yttrium oxide-based sintered body of Example 3.

### Example 4

The procedure of the Example 1 was repeated, except that weighing was performed so as to adjust the aluminum oxide of the sintered body to 0.5 mass %, to thereby produce an yttrium oxide-based sintered body of Example 4.

### Example 5

The procedure of the Example 2 was repeated, except that firing was performed at 1,500° C., to thereby produce an yttrium oxide-based sintered body of Example 5.

### Example 6

The procedure of the Example 2 was repeated, except that firing was performed at 1,700° C., to thereby produce an yttrium oxide-based sintered body of Example 6.

### Example 7

The procedure of the Example 2 was repeated, except that the aluminum oxide source was changed to aluminum oxide powder to alumina sol (mean grain size: 0.05 μm), to thereby produce an yttrium oxide-based sintered body of Example 7.

### Example 8

The procedure of the Example 2 was repeated, except that the firing time was change to 1 hour, to thereby produce an yttrium oxide-based sintered body of Example 8.

### Comparative Example 1

The procedure of the Example 1 was repeated, except that no aluminum oxide was added as a sintering aid, to thereby produce an yttrium oxide sintered body of Comparative Example 1.

### Comparative Example 2

The procedure of the Example 1 was repeated, except that weighing was performed so as to adjust the aluminum oxide of the sintered body to 0.6 mass %, to thereby produce a sintered body of Comparative Example 2 containing yttrium oxide and aluminum oxide.

### Comparative Example 3

The procedure of the Example 2 was repeated, except that a metal other than aluminum was intentionally added in an amount falling outside the scope of the present invention, to thereby produce a sintered body of Comparative Example 3 containing yttrium oxide and aluminum oxide.

### Comparative Example 4

The procedure of the Example 2 was repeated, except that firing was performed at 1,400° C., to thereby produce a sintered body of Comparative Example 4.

### Referential Examples 1 and 2

By use of the raw material powder of Example 1, sintered bodies having a relative density of 98.0% or higher were prepared. The sintered body of Referential Example 1 was formed only of yttrium oxide, and that of Referential Example 2 was formed only of aluminum oxide.

Method of Evaluation

Each of the sintered bodies of Examples, Comparative Examples, and Referential Examples was cut to provide test pieces. Each sample was subjected to the following measurement.

(1) Determination of Aluminum Oxide Content and Metallic Impurity Content of Sintered Body

The amount of aluminum oxide and the amount of metal other than aluminum and yttrium present in each sintered body test piece were determined through glow discharge mass spectrometry (GDMS).

(2) Measurement of Relative Density of Sintered Body

The density of each sintered body test piece was measured through Archimedes' principle. The relative density of the sintered body was calculated by “[(density of sintered body)/(theoretical density)]×100 (%).” As the theoretical density, a density of yttrium oxide (5.01 g/cm³) was employed in Examples, Comparative Examples, and Referential Example 1, and a density of aluminum oxide (4.0 g/cm³) was employed in Referential Example 2.

(3) Calculation of Mean Grain Size

A cross section image of each test piece was taken under an SEM (×1,000), and the thus-obtained photographic image was processed by image analysis software (WinROOF, product of Mitani Corporation), to thereby calculate a circle equivalent diameter. Thus, the mean grain size was determined. This measurement was performed in 3 vision fields selected at random.

(4) Determination of Complex Oxide Area Ratio in Sintered Body

Formation of a complex oxide of yttrium and aluminum was confirmed through high power XRD. The area ratio of the complex oxide of yttrium and aluminum was determined by taking a cross section image of each test piece under an SEM (×1,000), and processing the thus-obtained photographic image through image analysis by use of image analysis software (WinROOF, product of Mitani Corporation). The observation was performed in 3 vision fields (100 μm×100 μm) selected at random from the taken image.

(5) Plasma Resistance Test

Each test piece was mirror-polished at one surface. A portion of the polished surface was masked with polyimide tape. Then, the test piece was placed in a plasma-etching apparatus. The test piece was plasma-etched for 4 hours with NF₃ serving as an etching gas at a high-frequency power of 2,000 W in the etching apparatus (i.e., an RIE etching apparatus). The corrosion depth of the test piece after plasma etching was measured with respect to the level of the masked portion. A test piece exhibiting a corrosion depth of 0.7 μm or less was evaluated as a particularly excellent test piece, rated “00 (particularly excellent).” A test piece exhibiting a corrosion depth more than 0.7 μm and 0.8 μm or less was evaluated as an excellent test piece, rated “0 (fair).” A test piece exhibiting a corrosion depth more than 0.8 μm was evaluated as a failure test piece, rated “X (failure).”

Evaluation Results

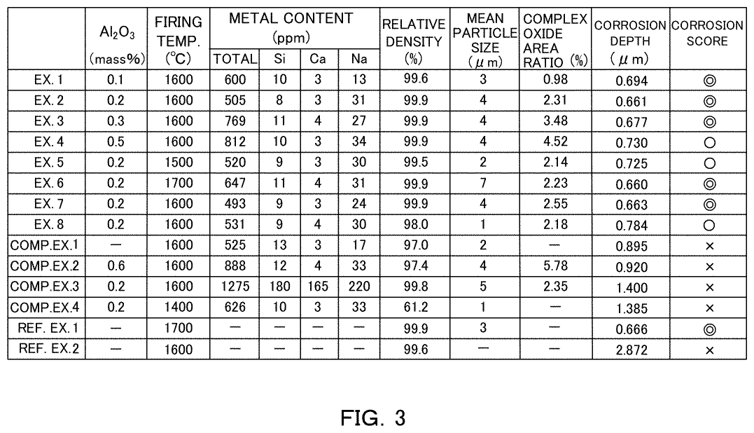

FIG. 3 is a table showing data relating to sintered bodies of Examples, Comparative Examples, and Referential Examples (proportions of raw materials, firing temperature for sintering, and evaluation scores). As is clear from Table 3, the yttrium oxide-based sintered bodies of Examples 1 to 8, falling within the scope of the present invention, were found to exhibit a plasma resistance comparable to that of a sintered body of Referential Example 1, produced through firing at 1,700° C., solely formed of yttrium oxide, and having a relative density of 99.9%.

Through X-ray diffraction (XRD) analysis, the yttrium oxide-based sintered bodies of the Examples were found to have a solo Y₂O₃ crystalline phase, and neither aluminum oxide crystalline phase nor an yttrium-aluminum complex oxide crystalline phase. In high-power XRD analysis, no aluminum oxide crystalline phase was detected. In other words, although the yttrium oxide-based sintered bodies of the Examples each contained aluminum oxide having poor plasma resistance, the sintered bodies were substantially formed of yttrium oxide. Therefore, the added aluminum oxide conceivably formed an yttrium-aluminum complex oxide, which had a plasma resistance higher than that of aluminum oxide. This is a conceivable reason why the yttrium oxide-based sintered body of the present invention has a plasma resistance almost equivalent to that of a high-purity yttrium oxide sintered body.

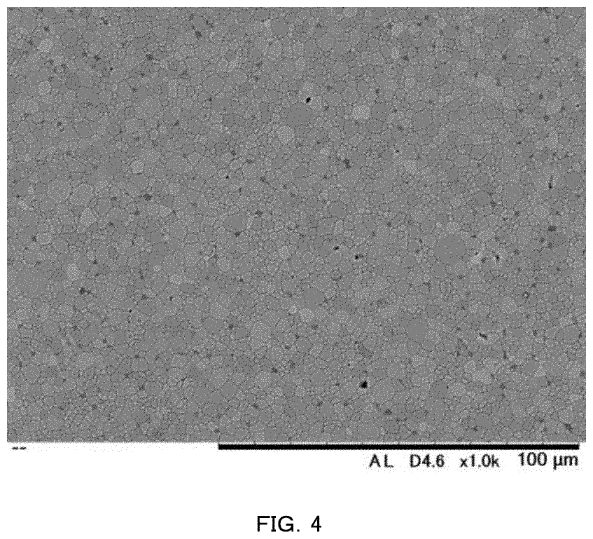

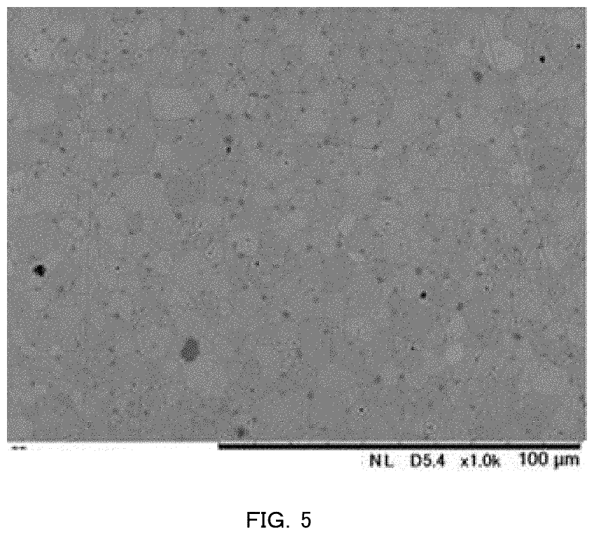

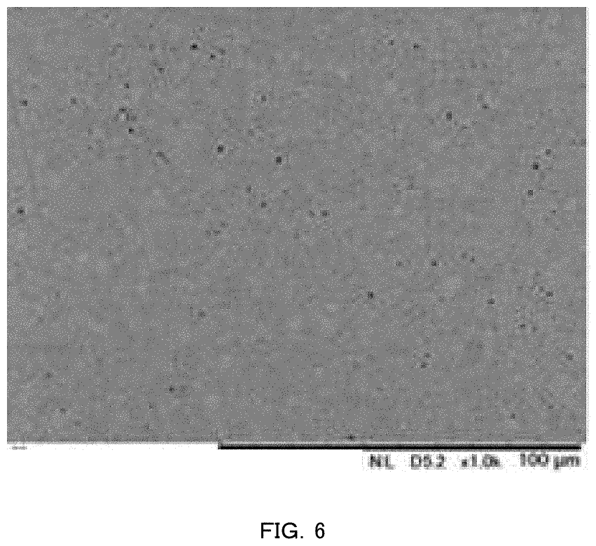

Among the test pieces of Examples 1 to 4 having varied aluminum oxide contents, those of Examples 2 and 3 exhibited particularly high plasma resistance. In addition, the test piece of Example 7 formed by use of alumina sol as an aluminum oxide source also exhibited high plasma resistance. The enhanced plasma resistance of Examples 2 and 3 is conceivably achieved by a preferred amount of added aluminum oxide. The enhanced plasma resistance of Example 7 is conceivably achieved by a preferred amount of added aluminum oxide and a more reduced mean grain size. FIGS. 4 to 6 are SEM images of the yttrium oxide-based sintered bodies of Examples 1, 6, and 7.

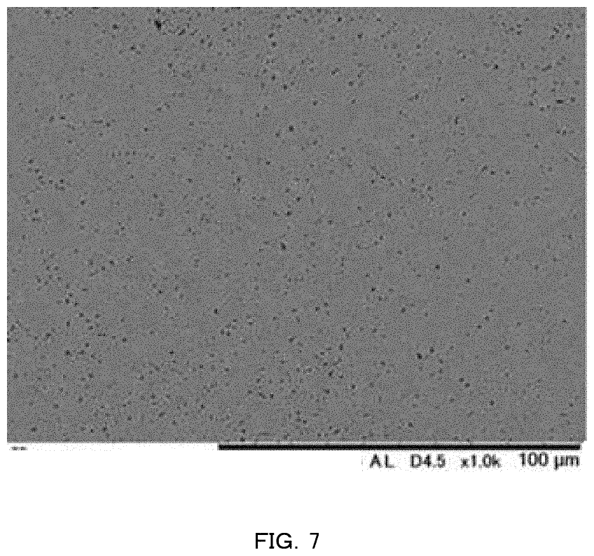

In contrast, as shown in Table 3, the raw material of Comparative Example 1 containing no aluminum oxide as a sintering aid could not be sintered at high density through firing at a temperature as employed in Example 1. Also, as shown in FIG. 7, a number of pores were present in the sintered body. FIG. 7 is an SEM image of the sintered body of Comparative Example 1. In FIG. 7, black dots denote pores. The sintered body of Comparative Example 1 failed to achieve excellent plasma resistance in the plasma resistance test, conceivably due to the presence of a number of pores which can proceed corrosion.

In Comparative Example 2, in which the aluminum oxide content was in excess of the upper limit of the scope of the present invention, excellent plasma resistance in the plasma resistance test failed to be attained, as compared with the cases of Examples and Referential Example 1. This is conceivably due to segregation of a part of aluminum oxide.

In Comparative Example 3, in which the metal (other than yttrium and aluminum) content fell outside the scope of the present invention, excellent plasma resistance in the plasma resistance test failed to be attained, as compared with the cases of Examples. This is conceivably due to the presence of a larger amount of a material having a plasma resistance lower than that of yttrium oxide or aluminum oxide.

The sintered body of Comparative Example 4, produced through sintering at a lower sintering temperature, was not densified, resulting in a considerably low relative density. Also, formation of a complex oxide of yttrium and aluminum was not detected. This is conceivably due to insufficient dissolution of aluminum oxide into yttrium oxide. Further, the plasma resistance was impaired. Conceivable reasons therefor include a reduced relative density, insufficient formation of a complex oxide, and occurrence of necking in the crystallographic structure.

As described hereinabove, the yttrium oxide-based sintered body of the present invention was found to exhibit a sufficiently high plasma resistance. According to the production method of the present invention, an yttrium oxide-based sintered body exhibiting a sufficiently high plasma resistance was found to be produced by firing at lower temperature. Also, the semiconductor production apparatus member of the present invention was found to achieve an enhanced plasma resistance, to exhibit excellent mechanical strength of the source sintered body, and to suitably serve as a large-scale member.

Needless to say, the aforementioned embodiment should not be construed as limiting the present invention. It should be understood that the present invention encompasses various modifications and equivalents, so long as they fall within the spirit and scope of the present invention. In addition, the structure, form, number, position, dimensions, etc. of any of the constitutional elements shown in the drawings are provided for the illustration purpose only, and they may be appropriately modified.

What is claimed is:

1. An yttrium oxide-based sintered body comprising yttrium oxide as a predominant component,
wherein the sintered body includes aluminum in an amount of 0.1 mass % to 0.5 mass % inclusive as reduced to aluminum oxide,
has a metal content of 1,000 ppm or less, the metal content excluding yttrium and aluminum, and
has a relative density of 98% or higher.

2. The yttrium oxide-based sintered body according to claim 1, having a mean grain size of 1 μm to 10 μm inclusive.

3. The yttrium oxide-based sintered body according to claim 1, wherein the sintered body includes a complex oxide of yttrium and aluminum, and
the complex oxide is present at an area ratio of 0.5% to 5% inclusive, the area ratio being determined in a Scanning Electron Microscope (SEM) image of a cross section of the sintered body.

4. The yttrium oxide-based sintered body according to claim 1,
having an Si content, a Ca content, and an Na content of 150 ppm or less, respectively.

5. A semiconductor production apparatus member comprising the yttrium oxide-based sintered body as recited in claim 1.

6. A method for producing an yttrium oxide-based sintered body, the method comprising the steps of:
weighing yttrium oxide and aluminum oxide so that the sintered body contains, after sintering, yttrium oxide in an amount of 99.4 mass % or more and aluminum in an amount of 0.1 mass % to 0.5 mass % inclusive, as reduced to aluminum oxide;
adding a binder to the weighed material and mixing;
granulating the mixed material to form a granulated powder;
forming the granulated powder into a compact; and
firing the compact at 1,500° C. to 1,700° C. inclusive.

7. The method according to claim 6, wherein the aluminum oxide is added as alumina sol.
